(19) United States
(12) Patent Application Publication
(10) Pub. No.: US 2025/0114961 A1
(43) Pub. Date: Apr. 10, 2025

(54) DIGITAL FLATBED CUTTERS

(71) Applicant: Vivid Laminating Technologies Ltd, Ashby de la Zouch (GB)

(72) Inventor: Gavin Ward, Ashby de la Zouch (GB)

(21) Appl. No.: 18/906,075

(22) Filed: Oct. 3, 2024

(30) Foreign Application Priority Data
Oct. 5, 2023 (GB) 2315266.3
Mar. 28, 2024 (GB) 2404445.5

(51) Int. Cl. B26F 1/38; B31D 1/02

(52) U.S. Cl. CPC B26F 1/3813; B31D 1/026

(57) ABSTRACT

A digital flatbed cutter includes a flatbed on which a printed workpiece can be positioned. A head unit of the digital flatbed cutter is movable laterally along an x-axis direction and along a perpendicular y-axis direction in a parallel plane above the flatbed. A primary cutter head is mounted to the head unit and includes a primary cutter assembly with a primary knife or blade for cutting the workpiece. The primary cutter assembly movable along a z-axis direction that is normal to the plane and perpendicular to the x- and y-axes. A selected cutter plate is removably mounted to the primary cutter assembly and optionally to a secondary cutter assembly of the digital flatbed cutter. The cutter plate includes at least one mounting means, each mounting means being configured to mount a respective secondary knife or blade for cutting the workpiece in parallel with the primary knife or blade.

### CROSS-REFERENCE PARAGRAPH TO RELATED APPLICATIONS

This application claims priority to United Kingdom Patent Application No. 2404445.5, filed on Mar. 28, 2024, and United Kingdom Patent Application No. 2315266.3, filed on Oct. 5, 2023, the entire contents of all of which are incorporated by reference herein.

### TECHNICAL FIELD

The invention relates to digital flatbed cutters, and in particular to cutters that can be used to cut a workpiece. The workpiece can comprise a sheet or roll of material such as card, paper, or label stock, for example.

### BACKGROUND OF THE INVENTION

Digital flatbed cutters are known. In a typical cutter of this type, a workpiece such as a sheet or roll of card, paper or label stock is placed on a flatbed. An example of a digital flatbed cutter is the VELOBLADER product supplied by Vivid Laminating Technologies Ltd of Matrix House, Norman Court, Ivanhoe Business Park, Ashby de la Zouch, Leicestershire, LE65 2UZ, United Kingdom.

The flatbed can be the upper part of a conveyor belt, for example. A sheet-feed can hold a stack of workpieces at one end of the conveyor belt, and the conveyor belt can move each workpiece in turn from the sheet-feed to a working position where it is cut by the cutter. Each workpiece is then moved by the conveyor belt to a collection tray. Each workpiece can already be printed with one or more images or designs and one or more registration marks.

The workpiece can also be supplied from a first roll upstream of the flatbed and gathered on a second roll downstream of the flatbed.

The digital flatbed cutter normally includes a head unit that is mounted above the flatbed on an assembly that can move the head unit in a controlled way in a parallel plane above the flatbed (i.e., in a plane defined by an x-axis and a perpendicular y-axis). The head unit can move in a first direction (i.e., a y-axis direction) along a support rail that extends over the flatbed. The support rail itself can move in a second direction (i.e., an x-axis direction) along side rails that are located at the sides of the flatbed, for example. The conveyor belt is normally configured to move the workpiece in the x-axis direction. If supplied from a roll, the workpiece normally moves over the flatbed in the x-axis direction.

The head unit can include a cutter head with a knife or blade for cutting the workpiece. The knife or blade can typically move vertically relative to the flatbed (i.e., along a z-axis direction that is perpendicular to both the x-axis and y-axis directions). In particular, the knife or blade can be moved between a first position where it is spaced apart from the workpiece and a second position where it is in contact with the workpiece for cutting. The head unit may also include other tool heads such as a creaser head with a creaser wheel for creasing the workpiece, for example.

The head unit can be aligned precisely with the workpiece before it is worked. For example, the head unit can include a camera and use optical recognition of the one or more printed registration marks on the workpiece or the outline of the workpiece on the flatbed. Once the head unit has been precisely aligned relative to the workpiece positioned on the flatbed, the workpiece can be cut by moving the head unit and operating the cutter head. The cutting of the workpiece can be based on information stored in a digital file that is used to control the operation of the digital flatbed cutter. In particular, the digital file can include cutting information for controlling the movement of the head unit in the x-axis and y-axis directions when the cutter head is being used to work the workpiece, and information for controlling the cutter head, for example to raise or lower the knife or blade of the cutter head.

A workpiece will often be printed with an array of discrete images or designs that need to be cut out individually using the digital flatbed cutter. For example, the printed workpiece may include an array of printed stickers, labels, postcards or business cards. The printed workpiece may include an (r×c) array of images or designs, where r is an integer indicating the number of images or designs arranged along the x-axis direction (i.e., number of rows) and c is an integer indicating the number of images or designs arranged along the y-axis direction (i.e., number of columns) when the workpiece is arranged on the flatbed. With a conventional digital flatbed cutter, the knife or blade of the cutter head will be used to cut around each individual image or design, and the cutting information will therefore include information for cutting around all of the images or designs in the (r×c) array. For example, the cutting information may include a matching (r×c) array of cutting outlines where each cutting outline extends generally around a respective printed image or design. The digital flatbed cutter will be controlled by the cutting information to position the head unit at a first location over the workpiece, lower the knife or blade, move the head unit to cut around the first image or design following a first cutting outline, lift the knife or blade and re-position the head unit at a second location over the workpiece, lower the knife or blade, move the head unit to cut around the second image or design following a second cutting outline, lift the knife or blade and re-position the head unit at a third location of the workpiece, and so on until the cutting process is complete.

### SUMMARY OF THE INVENTION

The present invention provides a digital flatbed cutter comprising:
a flatbed on which a printed workpiece can be positioned;
a head unit that is movable laterally along an x-axis direction and along a perpendicular y-axis direction in a parallel plane above the flatbed;
a primary cutter head mounted to the head unit and including a primary cutter assembly with a primary knife or blade for cutting the workpiece, the primary cutter assembly being movable along a z-axis direction that is normal to the plane and perpendicular to the x- and y-axes; and
a cutter plate removably mounted to the primary cutter assembly, the cutter plate comprising at least one secondary knife or blade for cutting the workpiece in parallel with the primary knife or blade.

The present invention further provides a digital flatbed cutter comprising:
a flatbed on which a printed workpiece can be positioned;
a head unit that is movable laterally along an x-axis direction and along a perpendicular y-axis direction in a parallel plane above the flatbed; and
a primary cutter head mounted to the head unit and including a primary cutter assembly with a primary knife or blade for cutting the workpiece, the primary cutter assembly being movable along a z-axis direction that is normal to the plane and perpendicular to the x- and y-axes;
wherein the primary cutter assembly is configured to removably mount a cutter plate. The cutter plate can comprise at least one secondary knife or blade for cutting the workpiece in parallel with the primary knife or blade. The cutter plate can comprise at least one mounting means, each mounting means being configured to mount a respective secondary knife or blade for cutting the workpiece in parallel with the primary knife or blade.

The present invention further provides a cutter plate configured to be removably mounted to a primary cutter assembly of a digital flatbed cutter, such as the digital flatbed cutter described above. The cutter can comprise at least one secondary knife or blade for cutting the workpiece in parallel with a primary knife or blade of the primary cutter assembly. The cutter plate can comprise at least one mounting means, each mounting means being configured to mount a respective secondary or blade for cutting a workpiece in parallel with a primary knife or blade of the primary cutter assembly.

Although the cutter plate is removably mounted (or configured to be removably mounted) to the primary cutter assembly, it will be readily understood that when mounted it will remain temporarily fixed to the primary cutter assembly until it is deliberately removed by a user so that during a cutting process a rigid mechanical connection is maintained between the cutter plate and the primary cutter assembly. The rigid mechanical connection ensures that the cutter plate moves in tandem with the primary cutter assembly, e.g., so that the one or more secondary knives or blades are raised and lowered in tandem with the primary knife or blade that is mounted on the primary cutter assembly, and that the one or more secondary knives or blades move in tandem with the primary knife or blade when the workpiece is being cut and the primary cutter head and assembly are being moved by the head unit. Put another way, the rigid mechanical connection ensures that any movement of the primary knife or blade is mirrored substantially exactly by each secondary knife or blade for consistent parallel cutting of the workpiece. The mounted cutter plate may be temporarily fixed to the primary cutter assembly by any suitable means, e.g., one or more mechanical fixings.

The cutter plate is preferably substantially rigid and can maintain a fixed orientation with respect to the primary cutter assembly during the cutting process. The cutter plate can be formed from any suitable material (e.g., metal) and can have any suitable shape or construction. For example, the cutter plate can have a flat or planar construction and can be shaped to be removably mounted to the primary cutter assembly and the optional secondary cutter assembly-see below.

When the cutter plate is mounted to the primary cutter assembly, the digital flatbed cutter may carry out two or more identical cutting actions simultaneously or in parallel. This is because the movement of the primary knife or blade is mirrored by each secondary knife or blade on the cutter plate. As described in more detail below, this can significantly reduce the time needed to cut around an array of printed images or designs. Because the cutter plate is removably mounted (or configured to be removably mounted) it may be removed or dismounted from the primary cutter assembly when it is not needed. Without the cutter plate, the digital flatbed cutter can be used like a conventional cutter where the cutting is carried out using the primary knife or blade only.

The cutter plate is movable along the z-axis direction by the primary cutter assembly. This means that all of the knives or blades of the digital flatbed cutter will be raised and lowered simultaneously by the action of the primary cutter assembly.

If the cutter plate includes mounting means for mounting the secondary knives or blades, the mounting means are preferably substantially evenly spaced along the cutter plate so that the secondary knifes or blades are substantially evenly spaced along the cutter plate. In other words, the secondary knifes or blades are preferably spaced apart by the same predetermined distance. When the cutter plate is mounted to the primary cutter assembly, the closest secondary knife or blade to the primary cutter assembly is preferably spaced apart from the primary knife or blade by the same predetermined distance—i.e., so that all of the knifes or blades of the digital flatbed cutter are spaced apart substantially evenly. The cutter plate is preferably mounted to the primary cutter assembly so that it extends substantially along the y-axis direction of the digital flatbed cutter. This means that the one or more secondary knifes or blades are also spaced apart along the y-axis direction of the digital flatbed cutter—i.e., they extend laterally across the width of the flatbed. The angle of the cutter plate relative to the primary cutter assembly may be fixed—e.g., so that it extends exactly along the y-axis of the digital flatbed cutter. If the workpiece is supplied from a roll that is upstream of the flatbed, and optionally gathered on a second roll downstream of the flatbed, the workpiece will normally be accurately positioned on the flatbed and it may not be necessary to adjust the angle of the cutter plate. More particularly, because the workpiece extends between the upstream and downstream rolls, the rows of images or designs are normally perfectly aligned along the y-axis direction of the digital flatbed cutter. Sheet workpieces are also normally accurately positioned on the flatbed, but it may be preferable to adjust the angle of the cutter plate relative to the primary cutter assembly in case the rows of images or designs are not perfectly aligned along the y-axis direction of the digital flatbed cutter. The cutter plate can therefore be pivotally mounted to the primary cutter assembly so that its angle can be adjusted to compensate for any slight misalignment of the workpiece on the flatbed before cutting. The angle can be adjusted by a suitable actuator, which may optionally be provided as part of a secondary cutter assembly or secondary cutter head-see below. If the flatbed digital cutter does not have a secondary cutter head or assembly, the actuator may be provided as part of the primary cutter head or assembly, for example. The actuator may be a linear actuator or a rotary actuator, for example. When the precise orientation of the workpiece on the flatbed has been determined, the actuator can be controlled (e.g., by a control unit) to automatically adjust the angle of the cutter plate as required to match the alignment of the workpiece. It is expected that only small angle adjustments will be required—for example, adjustments of less than +10° relative to the y-axis direction. Adjusting the angle of the cutting plate relative to the primary cutter assembly means that the cutter plate can be aligned perfectly with the rows of images or designs printed on the workpiece for more accurate parallel cutting.

Mounting a cutter plate with secondary knives or blades allows the digital flatbed cutter to efficiently cut a workpiece that includes an (r×c) array of images or designs. For example, if the workpiece is printed with a 4×3 array of discrete images or designs these may be efficiently cut around by using a cutter plate with two secondary knives or blades. When the cutter plate is mounted to the primary cutter assembly, the digital flatbed cutter will have a total of three knives or blades that are preferably substantially evenly spaced along the y-axis direction by the same predetermined distance. The knives or blades may therefore cut around the three images or designs in each row of the 4×3 array at the same time. It will be readily understood that the images or designs in the same row must be printed with an appropriate translation along the y-axis direction. In particular, a cutting outline followed by the primary knife or blade will be mirrored by each of the secondary knives or blades but translated or shifted in the y-axis direction. If the knives or blades are spaced apart by a predetermined distance D, the cutting outlines will be translated or shifted in the y-axis direction by the same predetermined distance D and the images or designs must be printed to that they are within each cutting outline. The cutting outlines in each row are identical and are translated in the y-axis direction without changing their size, shape or orientation. The secondary knives or blades will cut in tandem with the primary knife or blade (i.e., they will be moved up and down by the primary cutter assembly and also over the workpiece by the head unit on which the primary cutter head is mounted) so that each knife or blade cuts a row of identical cutting outlines. The cutting outlines in each row may have any suitable shape but their maximum dimension in the y-axis direction should not exceed the predetermined distance D between the knives or blades otherwise the cutting outlines being cut by the row of spaced knives or blades will overlap. When the first row of cutting outlines has been cut, the head unit will be re-positioned and the knives or blades will simultaneously cut the second row of cutting outlines etc. Although all of the cutting outlines in the array may often be identical, it is only necessary that the cutting outlines in a single row are identical because they are cut together in a single cutting action. Each row may have a different cutting outline. However, the cutting outlines for a particular workpiece will have the same translation in the y-axis direction if they are cut in parallel using the same cutter plate. The image or design printed within each cutting outline may be the same or different.

For further flexibility, a plurality of different cutter plates can be provided (e.g., as a kit) and the user may select and mount an appropriate cutter plate for a particular cutting process. Each cutter plate can have a different number of secondary knives or blades and/or each cutter plate can be configured for mounting two or more secondary knives or blades with different spacing therebetween (i.e., where the secondary knives or blades are spaced apart by different predetermined distances). Each cutter plate can be configured for mounting just one secondary knife or blade with a different spacing between the secondary knife or blade and the primary knife or blade when the cutter plate is mounted to the primary cutter assembly. Alternatively, the cutter plate can allow the spacing between the secondary knives or blades to be manually adjusted. In each case, the same spacing should preferably be provided between the secondary knife or blade that is closest to the primary cutter assembly and the primary knife or blade so that all of the knives or blades are preferably substantially evenly spaced apart along the y-axis direction when the cutter plate is mounted to the primary cutter assembly. The cutter plate can also allow the spacing between the closest secondary knife or blade and the primary knife or blade to be manually adjusted.

The primary cutter assembly may further comprise a plate mount configured for removably mounting a selected one of the plurality of different cutter plates.

In practice, it will be readily understood that the spacing between the knives or blades does not have to be the same—i.e., the knives or blades do not necessarily need to be evenly spaced along the y-axis direction. If the spacings are known, and remain fixed during the cutting process, the workpiece can be printed with an appropriate translation or shift between the images or designs in the same row. But it will normally be most convenient to make the spacing between the knives or blades the same because this can simplify the pre-printing process. A digital file for printing a workpiece can be created for use with a particular cutting plate so that the printed workpiece has an array of images or designs with an appropriate number of images or designs in each row and with the appropriate translation or shift between the images or designs. The workpiece can then be printed (e.g., by inkjet or laser printing) using the digital file in the knowledge that it can be efficiently cut using the digital flatbed cutter if a particular cutter plate is fitted. For example, if a particular cutter plate has n secondary knifes or blades, where n is an integer, and the same predetermined distance D between each knife or blade, the digital file for printing may include an (r×(n+1)) array of discrete images or designs, where (n+1) indicates the number of images or designs arranged along the y-axis direction (i.e., number of columns), and where the images or designs in each row are translated or shifted by the same predetermined distance D. If the primary and secondary knives or blades are spaced apart by different distances along the y-axis direction (e.g., with a distance D1 between the primary knife or blade and a first secondary knife or blade of the cutting plate, a distance D2 between the first secondary knife or blade and a second secondary knife or blade, and so on) the images or designs in each row will be appropriately translated or shifted (e.g., a translation of D1 between the first and second designs or images, a translation of D2 between the second and third designs or images, and so on).

Each secondary knife or blade can be removably mounted to the cutter plate. Each mounting means can have any suitable construction. Each mounting means can be an opening in the cutter plate for removably receiving a respective secondary knife or blade, for example. Each mounting means may also comprise a suitable fitting or connector that cooperates with a matching fitting or connector on the secondary knife or blade. The mounting means allow different types of secondary knife or blade to be fitted to a particular cutter plate. Each secondary knife or blade will remain temporarily fixed to the cutter plate or its respective mounting means until it is deliberately removed by a user. The primary knife or blade can also be removably mounted to the primary cutter assembly so that different types of primary knife or blade may be fitted to the primary cutter assembly.

A first end of the cutter plate can be removably mounted (or adapted to be removably mounted) to the primary cutter assembly. The digital flatbed cutter can further comprise a secondary cutter head including a secondary cutter assembly being movable in tandem with the primary cutter assembly. This includes movement of the secondary cutter assembly in the z-axis direction relative to the rest of the secondary cutter head. In other words, the primary and secondary cutter assemblies may be raised and lowered in tandem. A second end of the cutter plate can be removably mounted (or adapted to be removably mounted) to the secondary cutter assembly. Using a secondary cutter assembly helps to maintain the orientation of the cutter plate and may also help to avoid flexing of the cutter plate in the z-axis direction that may adversely affect the quality of the cutting. The digital flatbed cutter can further comprise a support rail that extends over the flatbed. The head unit can be configured to be movable along the support rail in the y-axis direction. The primary cutter head is mounted to the head unit and is moved along the support rail in the y-axis direction by the head unit. The secondary cutter head can be configured to be movable along the support rail in the y-axis direction in tandem with the head unit and the primary cutter head. The secondary cutter head is not necessarily driven to move along the support rail by its own actuator, but rather it can be moved along the support rail by the primary cutter head through the mechanical connection that is provided by the cutter plate. The secondary cutter head may be moved manually along the support rail by a user if the cutter plate is not connected to the secondary cutter assembly. The secondary cutter head will normally include a suitable actuator for raising and lowering the secondary cutter assembly in tandem with the primary cutter assembly. The secondary cutter head or assembly can also include a suitable actuator for adjusting the angle of the cutter plate relative to the primary cutter assembly as described above. In particular, the actuator may move the second end of the cutter plate forwards or backwards along the x-axis direction, with the first end of the cutter plate being pivotally mounted to the primary cutter assembly, so as to adjust the angle of the cutter plate. The pivot point for the cutter plate may be at the location of the primary knife or blade. Although the second end of the cutter plate will move relative to the secondary cutter assembly, it will be readily understood that the mechanical connection between the cutter plate and the secondary cutter assembly is maintained. Alternatively, a suitable actuator may be provided in the primary cutter head or assembly for adjusting the angle of the cutter plate—e.g., if the cutter plate is pivotally mounted to the primary cutter assembly, the actuator may be adapted to pivot the cutter plate about the pivot point. The pivot point for the cutter plate may be at the location of the primary knife or blade.

The flatbed can be a conveyor belt. The conveyor belt can be configured to move the workpiece along the x-axis direction.

As mentioned above, the head unit can be mounted on a support rail that extends over the flatbed. The head unit can be moved along the support rail (i.e., along the y-axis direction) by an actuator. The support rail can be mounted on one or more side rails.

The support rail can be moved along the one or more side rails (i.e., along the x-axis direction) by one or more actuators. The side rails can be located at opposite sides of the flatbed, for example, and are arranged substantially perpendicular to the support rail. The support rail and side rails allow the head unit to be moved in any direction under precise control in one or both of the x- and y-axes—i.e., in the parallel plane above the flatbed. It will be understood that other ways of moving the head unit under precise control can also be used.

The digital flatbed cutter can include a control unit that is configured to control the operation of the head unit, the primary cutter head and cutter assembly, and the optional secondary cutter head and cutter assembly. The control unit can control the operation of all actuators. The control unit can use a digital file that includes cutting information which specifies where the workpiece should be cut. If the cutter plate is fitted, the cutting information is preferably simplified to take account of the secondary knives or blades. For example, if the workpiece is printed with an (r×c) array of discrete images or designs, each image or design would normally be associated with a respective cutting outline so that the cutting information would normally include a matching or corresponding (r×c) array of discrete cutting outlines. But if a suitable cutter plate is fitted, the cutting information only needs to include one column of cutting outlines (e.g., an (r×1) array of discrete cutting outlines) that will be cut by the primary knife or blade. This is because the remaining cutting outlines will be automatically cut by the secondary knives or blades that are mounted to the cutter plate and they do not need to be included as cutting information in the digital file.

In use, a workpiece is positioned on the flatbed. The head unit is precisely aligned with the workpiece on the flatbed. For example, the head unit can include a camera or other optical device and the control unit can use optical recognition of one or more printed registration marks on the workpiece or the outline of the workpiece. The optical recognition allows the control unit to know the precise position and orientation of the workpiece on the flatbed and to precisely align the head unit with the workpiece. Once the head unit has been precisely aligned, the workpiece can be cut by the primary knife or blade and the one or more secondary knives or blades mounted to the cutter plate.

The optical recognition can also be used to allow the control unit to automatically adjust the angle of the cutter plate to compensate for any misalignment of the workpiece on the flatbed—i.e., where the rows of printed images or designs are not exactly aligned with the y-axis direction of the digital flatbed cutter.

When the cutter plate is not required, it may be removed from the primary cutter assembly and the digital flatbed cutter may be used conventionally. If a secondary cutter head is provided, the cutter plate is also removed from the secondary cutter assembly and the secondary cutter head may be manually moved to a “parking” area on the support rail where it will not interfere with the conventional operation of the digital flatbed cutter.

The present invention further provides a method of using a digital flatbed cutter comprising:
a flatbed;
a head unit that is movable laterally along an x-axis direction and along a perpendicular y-axis direction in a parallel plane above the flatbed; and
a primary cutter head mounted to the head unit and including a primary cutter assembly with a primary knife or blade for cutting the workpiece, the primary cutter assembly being movable along a z-axis direction that is normal to the plane and perpendicular to the x- and y-axes;
the method comprising:
mounting a cutter plate to the primary cutter assembly, the cutter plate comprising at least one secondary knife or blade for cutting the workpiece in parallel with the primary knife or blade;
positioning a workpiece on the flatbed; and
cutting the workpiece with each secondary knife or blade cutting the workpiece in parallel with the primary knife or blade.

The cutter plate can be selected from a plurality of different cutter plates, e.g., with a different number of secondary knives or blades and/or different spacing between the secondary knives or blades.

The angle of the cutter plate relative to the primary cutter assembly can be adjusted before the workpiece is cut.

The present invention further provides a digital flatbed cutter comprising:
a flatbed on which a printed workpiece can be positioned;
a head unit that is movable laterally along an x-axis direction and along a perpendicular y-axis direction in a parallel plane above the flatbed;
a primary cutter head mounted to the head unit and including a primary cutter assembly with a primary knife or blade for cutting the workpiece, the primary cutter assembly being movable along a z-axis direction that is normal to the plane and perpendicular to the x- and y-axes; and
at least one secondary knife or blade movable in tandem with the primary knife or blade for cutting the workpiece in parallel with the primary knife or blade;
wherein the primary knife or blade and the at least one secondary knife or blade are aligned and spaced apart along a cutter axis; and
wherein the angle of the cutter axis relative to the y-axis is adjustable.

The cutter axis may be defined by a straight line that passes through the primary knife or blade and each secondary knife or blade.

The knives or blades may be substantially evenly spaced apart along the cutter axis, i.e., they may be spaced apart by the same predetermined distance as described above.

The at least one secondary knife or blade may be mounted in any suitable way that allows each secondary knife or blade to move in tandem with the primary knife or blade.

This include movement in the x- and y-axes in the parallel plane about the flatbed, and movement in the z-axis direction, i.e., so that each secondary knife or blade moves up and down with the primary knife or blade. In one arrangement, which is described in more detail above, the digital flatbed cutter may further comprise a cutter plate mounted to the primary cutter assembly. The cutter plate will move in tandem with the primary cutter assembly and may be used to mount the at least one secondary knife or blade as described above. The cutter plate may therefore comprise the at least one secondary knife or blade. However, the at least one secondary knife or blade may also be mounted without using a cutter plate, for example by being mounted on the primary cutter assembly or where both the primary knife or blade and the at least one secondary knife or blade are mounted on a common cutter assembly that is part of the primary cutter head and movable along a z-axis direction.

The cutter plate may extend substantially along the y-axis direction, but its angle relative to the y-axis (e.g., relative to the primary cutter assembly) is adjustable. The cutter axis may be parallel to a longitudinal axis of the cutter plate. Adjusting the angle of the cutter plate will adjust the angle of the cutter axis. If a cutter plate is not provided, the angle of the cutter axis may be adjusted in another way, e.g., by moving each secondary knife or blade along the x-axis direction. Each secondary knife or blade may be moved along the x-axis direction by a suitable actuator, for example.

The cutter plate may be pivotally mounted to the primary cutter assembly.

The cutter plate may be removably mounted to the primary cutter assembly as described in more detail above.

The cutter plate may include at least one mounting means, each mounting means being configured to mount a respective secondary or blade. Each secondary knife or blade may be removably mounted to the cutter plate.

The at least one secondary knife or blade may be integrally formed with the cutter plate.

A plurality of different cutter plates may be provided, e.g., with a different number of secondary knives or blades and/or different spacing between the secondary knives or blades. The primary cutter assembly may also comprise a plate mount configured for removably mounting a selected one of the plurality of cutter plates. If a cutter plate is not provided, the spacing between the knives or blades along the cutter axis may be adjusted in another way, e.g., where each secondary knife or blade is moved along the cutter axis by a suitable actuator.

A first end of the cutter plate may be removably mounted to the primary cutter assembly. The digital flatbed cutter may further comprise a secondary cutter head including a secondary cutter assembly being movable in tandem with the primary cutter assembly. A second end of the cutter plate may be removably mounted to the secondary cutter assembly. The first end of the cutter plate may be pivotally mounted to the primary cutter assembly and the position of the second end of the cutter plate may be adjusted in the x-axis direction to adjust the angle of the cutter plate and the cutter axis. The second end of the cutter plate may be moved by a suitable actuator that forms part of the secondary cutter head or assembly. As described above, the suitable actuator may alternatively form part of the primary cutter head or assembly.

The digital flatbed cutter may further comprise a support rail that extends over the flatbed. The head unit may be configured to be movable along the support rail in the y-axis direction. The secondary cutter head may be configured to be movable along the support rail in the y-axis direction in tandem with the head unit and the primary cutter head.

The present invention further provides a method of using a digital flatbed cutter comprising:
a flatbed;
a head unit that is movable laterally along an x-axis direction and along a perpendicular y-axis direction in a parallel plane above the flatbed;
a primary cutter head mounted to the head unit and including a primary cutter assembly with a primary knife or blade for cutting the workpiece, the primary cutter assembly being movable along a z-axis direction that is normal to the plane and perpendicular to the x- and y-axes; and
at least one secondary knife or blade movable in tandem with the primary knife or blade, wherein the primary knife or blade and the at least one secondary knife or blade are aligned and spaced apart along a cutter axis;
the method comprising:
positioning a workpiece on the flatbed; and
cutting the workpiece with each secondary knife or blade cutting the workpiece in parallel with the primary knife or blade.

The method may further comprise adjusting the angle of the cutter axis relative to the y-axis before cutting the workpiece.

The angle of the cutter axis may be adjusted based on the orientation of the workpiece on the flatbed. As described above, optical recognition can be used to allow the control unit to automatically adjust the angle of the cutter axis to compensate for any misalignment of the workpiece on the flatbed.

The method may further comprise pivotally mounting a cutter plate to the primary cutter assembly. The cutter plate may comprise the at least one secondary knife or blade. The angle of the cutter plate relative to the primary cutter assembly may be adjusted before cutting the workpiece.

### DRAWINGS

FIG. 1 is a schematic front view of a digital flatbed cutter according to the present invention without a cutter plate fitted;

FIG. 2A is a schematic side view of the digital flatbed cutter of FIG. 1;

FIG. 2B is a schematic side view of the digital flatbed cutter of FIG. 1;

FIGS. 3A and 3B are schematic front views of the digital flatbed cutter of FIG. 1 with a cutter plate fitted;

FIGS. 3C and 3D are schematic front views of an alternative digital flatbed cutter with a cutter plate fitted but without a secondary cutter assembly;

FIGS. 4A, 4B and 4C are schematic front views of different cutter plates according to the present invention;

FIG. 5 is a top view of a first printed workpiece;

FIG. 6 is a visual representation of a first digital file for controlling the digital flatbed cutter according to the present invention;

FIG. 7 is a top view of a second printed workpiece;

FIG. 8 is a visual representation of a second digital file for controlling the digital flatbed cutter according to the present invention;

FIG. 9 is a top view of a third printed workpiece;

FIG. 10 is a visual representation of a third digital file for controlling the digital flatbed cutter according to the present invention;

FIGS. 11A and 11B are schematic top views showing how the angle of the cutter plate can be adjusted; and

FIGS. 12A and 12B are schematic top views showing how the angle of the cutter axis can be adjusted if there is no cutter plate.

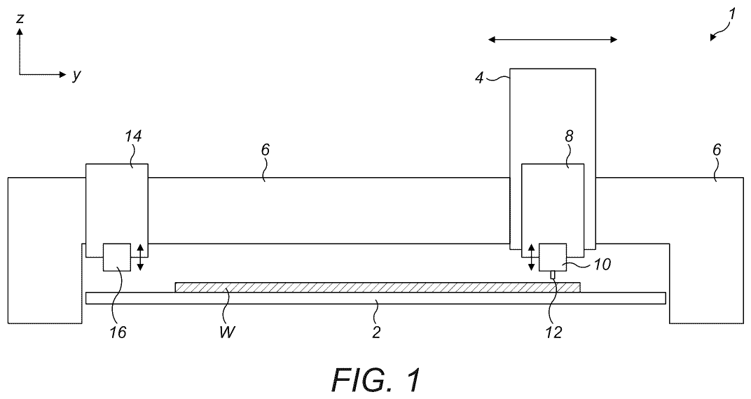

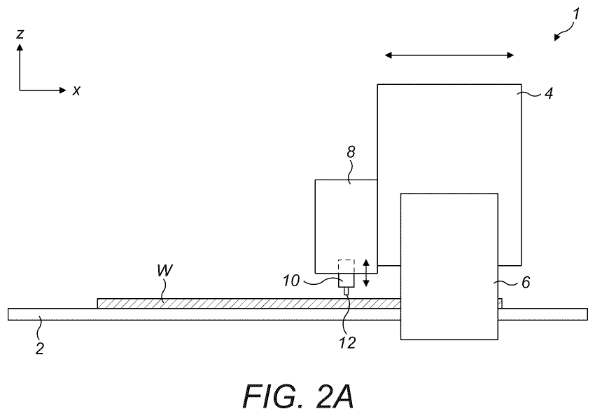

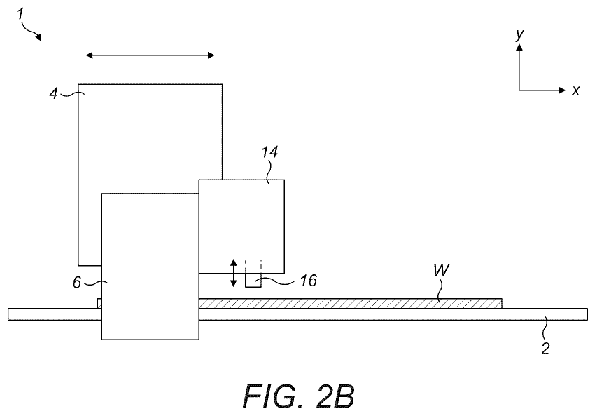

As shown in FIGS. 1, 2A, 2B, 3A and 3B, a digital flatbed cutter 1 includes a flatbed 2 on which a printed workpiece W can be positioned.

A head unit 4 is mounted above the flatbed 2. The head unit 4 is mounted on a support rail 6 and can move from side-to-side along the support rail (i.e., along a y-axis direction) by a suitable actuator (not shown). The support rail 6 is mounted on side rails (not shown) and can move backwards and forwards along the side rails (i.e., along an x-axis direction) by one or more suitable actuators (not shown). The actuators are controlled by a control unit (not shown) which can include a suitable processor and a user input device such as a touch display screen or keypad, for example. By controlling the actuators, the head unit 4 can be positioned precisely and can be moved in any direction in a parallel plane above the flatbed 2 defined by the perpendicular x- and y-axes.

The head unit 4 includes a primary cutter head 8 with a primary cutter assembly 10 that is mounted so that it can move along the axis that is normal to the plane (i.e., along the z-axis direction) relative to the head unit. The primary cutter assembly 10 includes a primary knife or blade 12 that may be removably mounted. The primary cutter assembly 10 can be moved by an actuator between a first position-shown in FIGS. 1, 2A, 2B, 3A and 3B—where the primary knife or blade 12 is spaced apart from the workpiece W and a second position where the primary knife or blade is in contact with the workpiece for cutting.

A secondary cutter head 14 is mounted on the support rail 6 and can move from side-to-side along the support rail (i.e., along the y-axis direction). In particular, the secondary cutter head 14 is mounted directly to the support rail 6, not indirectly like the primary cutter head 8 which is mounted to the head unit 4. The secondary cutter head 14 includes a secondary cutter assembly 16 that is mounted so that it be moved by an actuator along the z-axis direction in tandem with the primary cutter assembly 10. In FIG. 1, the secondary cutter head 14 is shown in a “parking” area at an end of the support rail 6 where it may remain when it is not required—e.g., when only the primary knife or blade 12 is being used to cut the workpiece.

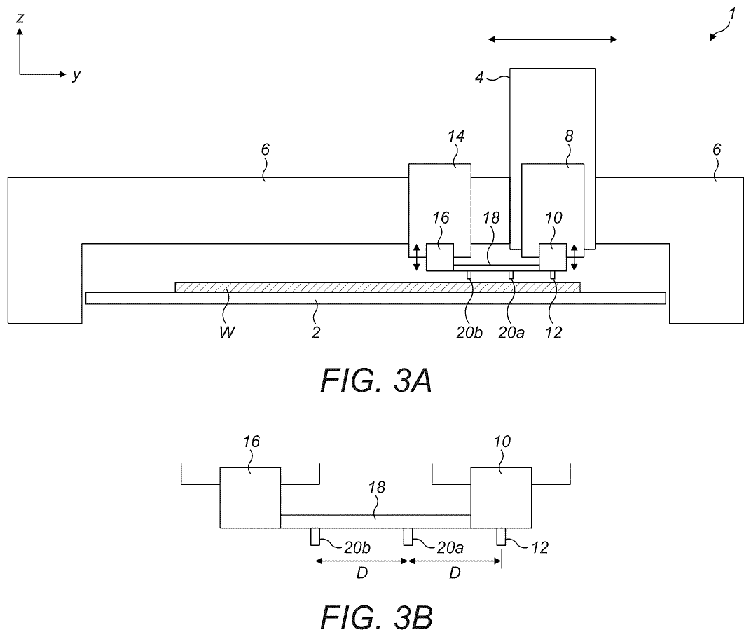

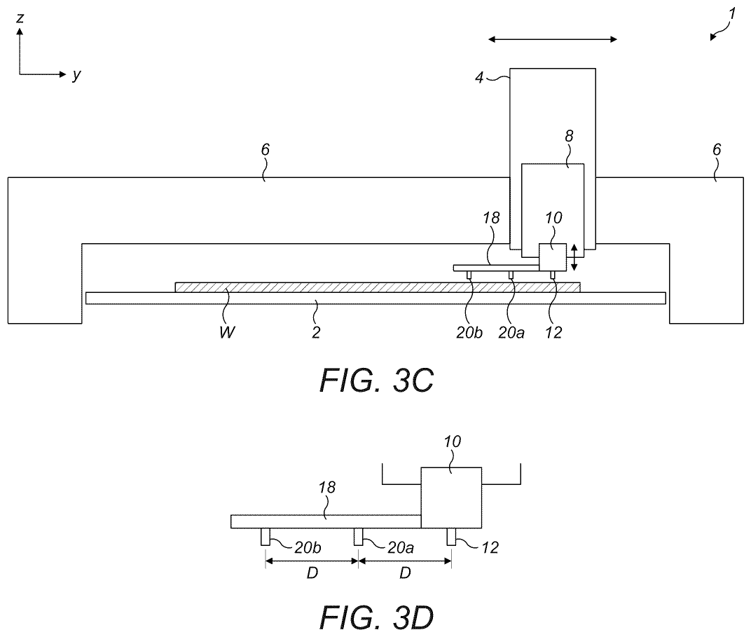

FIGS. 3A and 3B show a cutter plate 18 that is removably mounted between the primary and secondary cutter assemblies 10, 16. More particularly, a first end of the cutter plate 18 is removably mounted to the primary cutter assembly 10 and a second end of the cutter plate is removably mounted to the secondary cutter assembly 16 as shown. The cutter plate 18 is substantially rigid and extends along the y-axis direction.

The cutter plate 18 is raised and lowered by the primary and secondary cutter assemblies 10, 16 which can be moved along the z-axis direction in tandem. A pair of secondary knives or blades 20a, 20b are removably mounted to the cutter plate 18. For example, the cutter plate 18 may include a pair of mounting openings or other mounting means to which each secondary knife or blade is fixed. Each secondary knife or blade 20a, 20b will remain temporarily fixed to the cutter plate 18 until it is deliberately removed by a user. Secondary knives or blades may therefore be used with different cutter plates. In other words, once a particular cutter plate has been selected, the required number of secondary knives or blades can be fixed to the cutter plate before it is mounted to the digital flatbed cutter. This avoids the need for each of the cutter plates to include one or more fixed secondary knives or blades. It also means that different types of secondary knives or blades can be used for different cutting processes or for different types of workpiece. Alternatively, the cutter plate can also have one or more fixed secondary knives or blades that are optionally integral with the cutter plate—i.e., not removably mounted—and the mounting means may therefore be omitted.

The secondary knives or blades 20a, 20b are spaced apart by a distance D (FIG. 3B). When the cutter plate 18 is mounted to the primary cutter assembly 10, the secondary knife or blade 20a is spaced apart from the primary knife or blade 12 by the same distance D. This means that all three knives or blades are evenly spaced along the y-axis direction.

The secondary cutter head 14 and the secondary cutter assembly 16 are not essential. FIGS. 3C and 3D show a flatbed digital cutter 1 without the secondary cutter head 14 and the secondary cutter assembly 16. In this case, the second end of the cutter plate 18 is not supported.

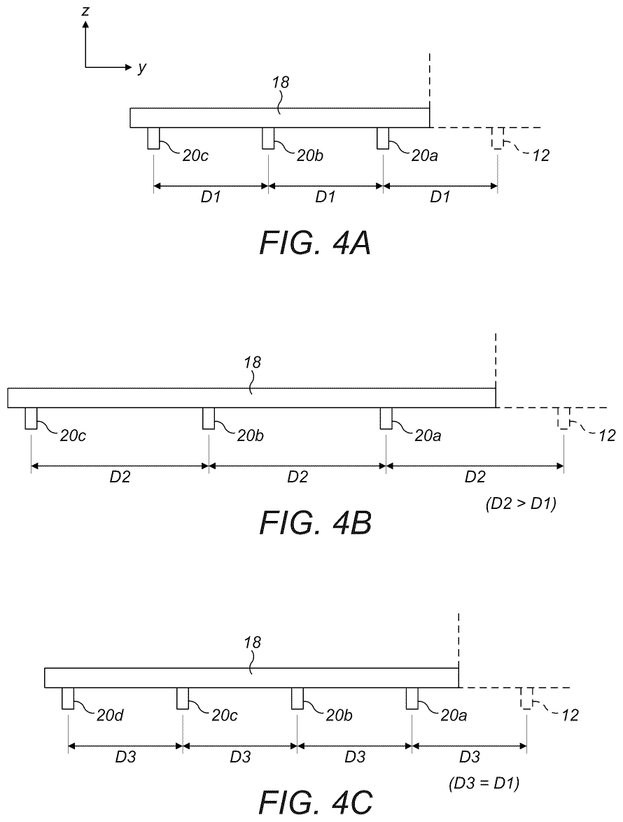

The cutter plate 18 may be selected from a plurality of different cutter plates. FIGS. 4A, 4B and 4C show some examples of different cutter plates 18 that include different numbers of secondary knives or blades, and/or different spacings. In all cases, the secondary knives or blades are evenly spaced apart along the y-axis direction. The secondary knife or blade 20a that is closest to the primary knife or blade 12 (shown ghosted) is also spaced apart from the primary knife of blade by the same predetermined distance so that all of the knives or blades are evenly spaced along the y-axis direction. FIG. 4A shows a cutter plate 18 with three secondary knives or blades 20a, 20b, and 20c that are spaced apart by a predetermined distance D1. FIG. 4B shows a cutter plate 18 with three secondary knives or blades 20a, 20b and 20c that are spaced apart by a predetermined distance D2, where D2 is greater than D1. FIG. 4C shows a cutter plate 18 with four secondary knives or blades 20a, 20b, . . . , 20d that are spaced apart by a predetermined distance D3, wherein D3 is equal to D1. A suitable cutter plate 18 may be selected and fitted to the digital flatbed cutter 1.

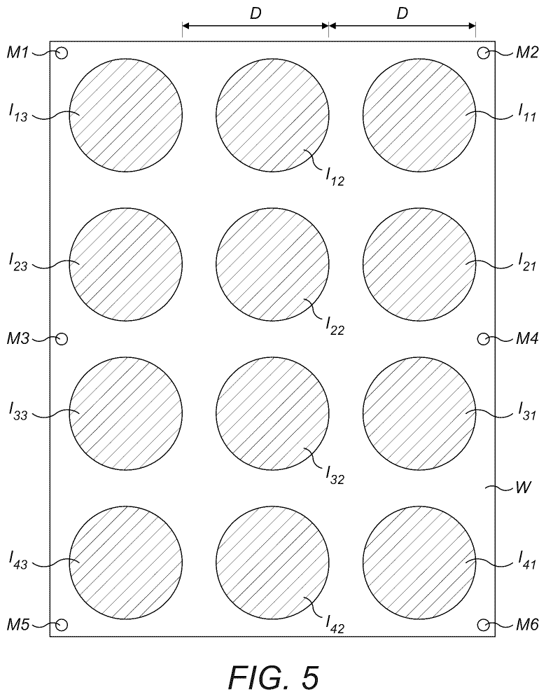

FIG. 5 shows a first printed workpiece W that may be conveniently cut using the cutter plate 18 shown in FIGS. 3A and 3B—i.e., with two secondary knifes or blades 20a, 20b spaced apart by a predetermined distance D. The workpiece W may be a printed sheet of paper, card, or label stock, for example. The workpiece W is printed with a 4×₃ array of discrete images or designs I₁₁, I₁₂, I₁₃, I₂₁, . . . , I₄₃. The images or designs may be printed by any suitable printing process such as inkjet printing or laser printing, for example. The images or designs in each row are translated or shifted in the y-axis direction by the predetermined distance D that matches the spacing between the knives or blades.

The operation of the digital flatbed cutter 1 is controlled by a control unit (not shown).

The movement of the head unit 4 during a cutting process can be controlled by the control unit using a digital file.

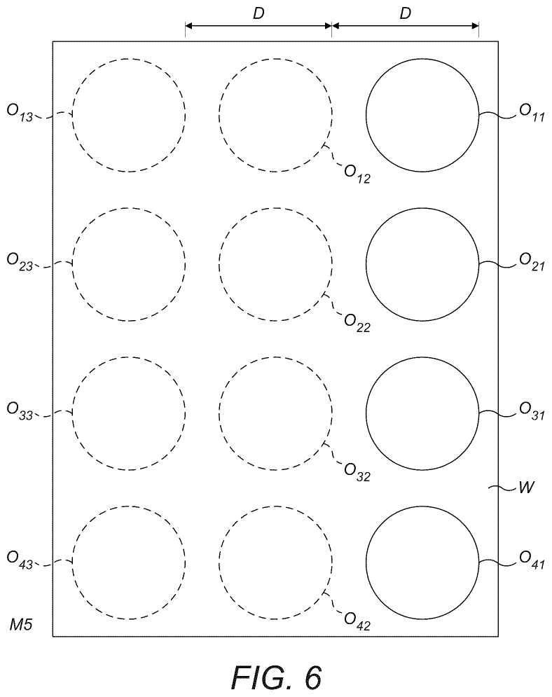

A visual representation of the digital file for cutting the first printed workpiece W is shown in FIG. 6 where cutting information is shown in solid line. The cutting information includes a column of identical cutting outlines O₁₁, O₂₁, . . . . O₄₁. The cutting outlines O₁₁, O₂₁, . . . . O₄₁ indicate where the first workpiece W shown in FIG. 5 should be cut by the primary knife or blade 12. The workpiece W will be cut in parallel by the secondary knifes or blades 20a, 20b on the cutter plate 18. These identical cutting outlines are shown in dashed line but do not form part of the cutting information that is used by the control unit. It will be understood that the cutting outlines O₁₁, O₂₁, . . . . O₄₁ are only provided as a simple example, and that in practice they can have any suitable shape and will normally be determined by the shape of the printed areas on the workpiece that are to be cut around.

The first workpiece W also includes six printed registration marks M1, M2, . . . , M6.

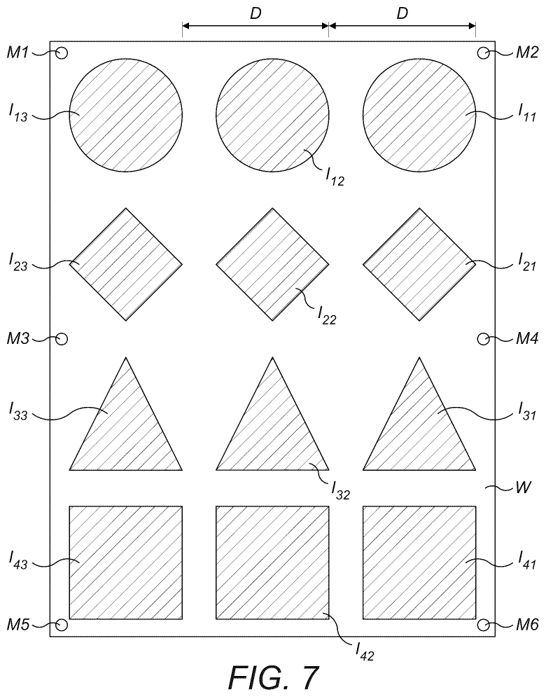

FIG. 7 shows a second printed workpiece W that may be conveniently cut using the cutter plate 18 shown in FIGS. 3A and 3B—i.e., with two secondary knifes or blades 20a, 20b spaced apart by a predetermined distance D. The workpiece W may be a printed sheet of paper, card, or label stock, for example. The workpiece W is printed with a 4×3 array of discrete images or designs I₁₁, I₁₂, I₁₃, I₂₁, . . . , I₄₃. The images or designs may be printed by any suitable printing process such as inkjet printing or laser printing, for example. The images or designs in each row are translated or shifted in the y-axis direction by the predetermined distance D that matches the spacing between the knives or blades. In this second workpiece W, the images or designs in the same row have the same shape, but the shape of the images or designs in each row is different.

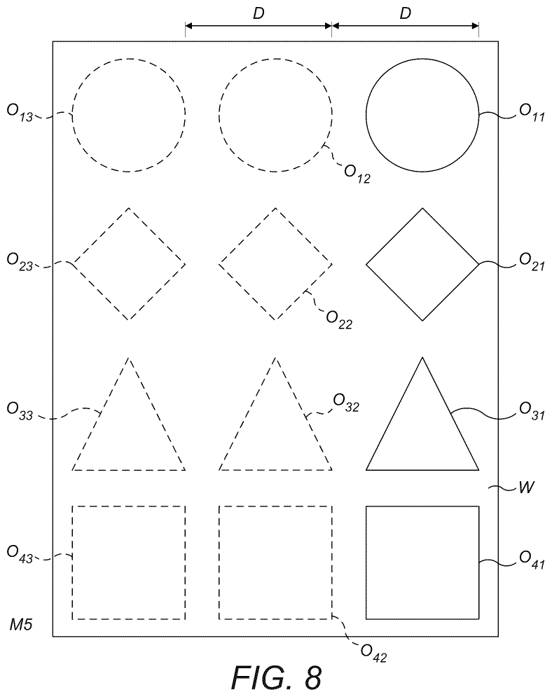

A visual representation of the digital file for cutting the second printed workpiece W is shown in FIG. 8 where cutting information is shown in solid line. The cutting information includes a column of cutting outlines O₁₁, O₂₁, . . . . O₄₁. The cutting outlines O₁₁, O₂₁, . . . . O₄₁ indicate where the second workpiece W shown in FIG. 7 should be cut by the primary knife or blade 12. The workpiece W will be cut in parallel by the secondary knifes or blades 20a, 20b on the cutter plate 18. These cutting outlines are shown in dashed line but do not form part of the cutting information.

The second workpiece W also includes six printed registration marks M1, M2, . . . , M6.

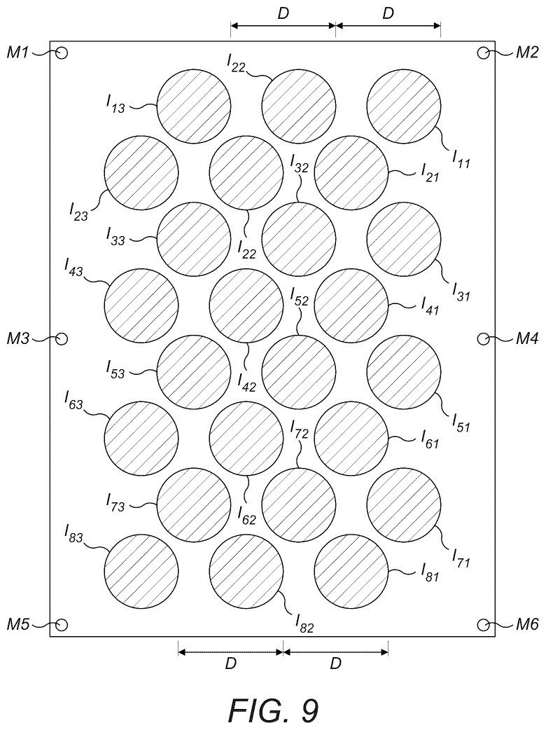

FIG. 9 shows a third printed workpiece W that may be conveniently cut using the cutter plate 18 shown in FIGS. 3A and 3B—i.e., with two secondary knifes or blades 20a, 20b spaced apart by a predetermined distance D. The workpiece W may be a printed sheet of paper, card, or label stock, for example. The workpiece W is printed with an 8×3 array of discrete images or designs I₁₁, I₁₂, I₁₃, I₂₁, . . . , I₈₃. The images or designs may be printed by any suitable printing process such as inkjet printing or laser printing, for example. The images or designs in each row are translated or shifted in the y-axis direction by the predetermined distance D that matches the spacing between the knives or blades. In this workpiece, the images or designs have the same shape but the rows are shifted with respect to each other.

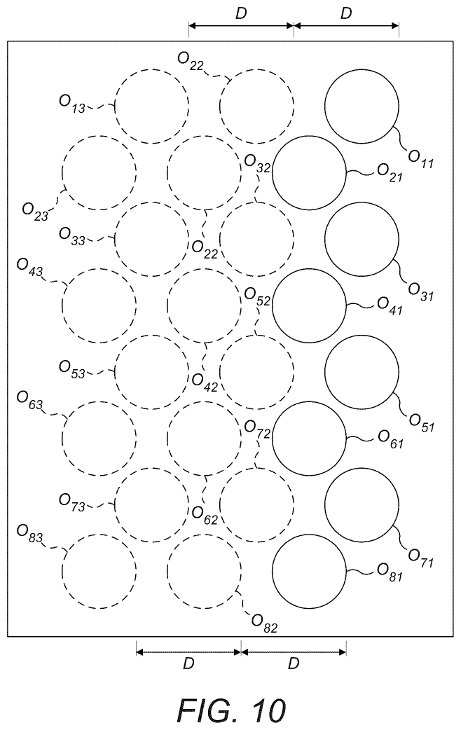

A visual representation of the digital file for cutting the third printed workpiece W is shown in FIG. 10 where cutting information is shown in solid line. The cutting information includes a column of cutting outlines O₁₁, O₂₁, . . . O₈₁. The cutting outlines O₁₁, O₂₁, . . . . O₈₁ indicate where the third workpiece W shown in FIG. 9 should be cut by the primary knife or blade 12. The workpiece W will be cut in parallel by the secondary knifes or blades 20a, 20b on the cutter plate 18. These cutting outlines are shown in dashed line but do not form part of the cutting information.

The third workpiece W also includes six printed registration marks M1, M2, . . . , M6.

The workpiece W shown in FIG. 5, 7 or 9 is positioned on the flatbed 2 using the feed mechanism (not shown). A stack of identical printed workpieces can be located at an end of the flatbed 2 and an individual workpiece can be picked from the stack and positioned on the flatbed. The head unit 4 is precisely aligned with the workpiece W. For example, the head unit 4 can include a camera (not shown) and the control unit can use optical recognition of the printed registration marks M1, M2, . . . , M6 to determine the precise position and orientation of the workpiece W on the flatbed 2. Once the head unit 4 has been precisely aligned relative to the workpiece W, the workpiece can be cut by the primary knife or blade 12. The workpiece W will also be cut in parallel by the secondary knives or blade 20a, 20b. In particular, the control unit can position the head unit 4 over the workpiece W so that the knives or blades are at the required position for cutting around the first row of the images or designs I₁₁, I₁₂, I₁₃. The control unit lowers the primary and secondary cutter assemblies 10, 16—and hence the cutter plate 18—until the primary and secondary knives or blades are in contact with the workpiece W. The control unit will then move the head unit 4 with the knives or blades in contact with the workpiece W to cut around the first row of images or designs—i.e., to simultaneously cut around the cutting outlines O₁₁, O₁₂, O₁₃. The control unit raises the primary and secondary cutter assemblies 10, 16 to lift the primary and secondary knives or blades from the workpiece and re-positions the heat unit 4 over the workpiece so that the knives or blades are at the required position for cutting around the second row of images or designs I₂₁, I₂₂, I₂₃. The control unit lowers the primary and secondary cutter assemblies 10, 16 until the primary and secondary knives or blades are in contact with the workpiece W. The control unit will then move the head unit 4 with the knives or blades in contact with the workpiece W to cut around the second row of images or designs—i.e., to simultaneously cut around the cutting outlines O₂₁, O₂₂, O₂₃. The same process is carried out to cut around the remaining rows. By using the cutter plate 18 with secondary knives or blades 20a, 20b, the digital flatbed cutter 1 can cut around an entire row of printed images or designs in the same time as it would have previously been possible to cut around a single image or design. It will be readily understood that a different cutter plate with three, four or five secondary knives or blades can be used to cut around an (r×4), (r×5) or (r×6) array of discrete images or designs, where r is an integer indicating the number of images or designs arranged along the x-axis direction (i.e., number of rows). In general terms, a cutter plate with n secondary knives or blades can be used to cut around an (r×(n+1)) array of discrete images or designs, where n is an integer and (n+1) indicates the number of images or designs arranged along the y-axis direction (i.e., number of columns).

Movement of head unit 4 along the support rail 6 also moves the secondary cutter head 16 along the support rail because the cutter plate 18 is mechanically connected between the primary and secondary cutter assemblies 10, 16.

The digital flatbed cutter 1 can include a feed mechanism (not shown) for positioning a workpiece on the flatbed 2. Any suitable feed mechanism can be used, e.g., a vacuum feed that can be integrated into the head unit 4 or the support rail 6 and which can be used to pick up an individual workpiece from a stack and position it on the flatbed 2.

The flatbed 2 can be a conveyor belt which can be used to support the workpiece W while it is being worked and move the workpiece to a collection tray. The workpiece can alternatively be supplied from a roll (not shown).

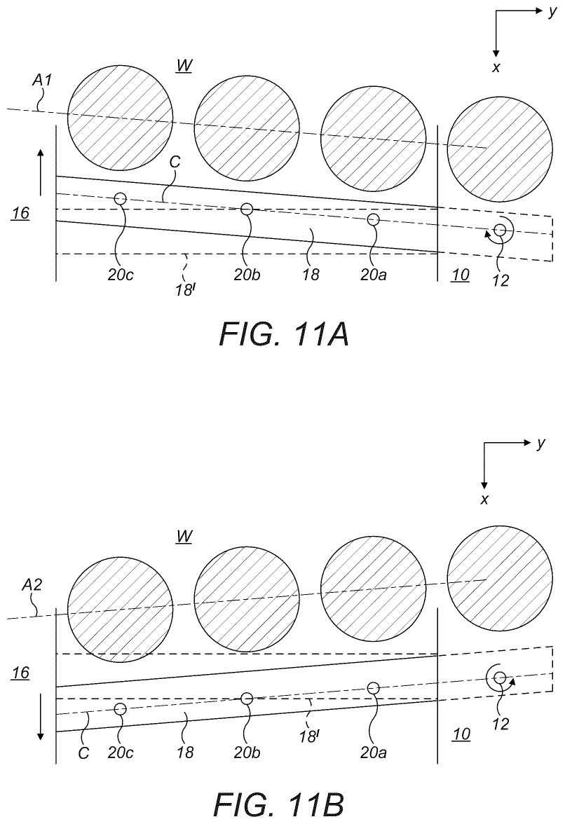

FIGS. 11A and 11B show how the angle of the cutter plate 18 can be adjusted to match the alignment A1, A2 of the rows of printed images or designs on the workpiece W. In particular, the first end of the cutter plate 18 is pivotally connected to the primary cutter assembly 10 and the secondary cutter assembly 16 includes a suitable actuator (not shown) that can move the second end of the cutter plate along the x-axis direction. A suitable actuator (not shown) may alternatively be provided as part of the primary cutter head or assembly 8, 10 and may adjust the angle of the cutter plate 18. This may be the case if the flatbed digital cutter 1 does not include a secondary cutter head 14, for example. The cutter plate 18 pivots about the location point of the primary knife or blade 12. The cutter axis C is shown as a straight line that passes through the primary knife or blade 12 and the secondary knives or blades 20a, 20b and 20c. It can be seen that the cutter axis C is parallel to a longitudinal axis of the cutter plate 18. In this example, the printed images or designs are not exactly aligned along the y-axis direction because of how the workpiece W is positioned on the flatbed 2. The misalignment is detected (e.g., using optical recognition of printed registration marks on the workpiece W) and the actuator is controlled to move the second end of the cutter plate 18 an appropriate distance along the x-axis direction so that the angle of the cutter plate 18 matches the alignment A1, A2 of the printed images or designs—i.e., until the cutter axis C is parallel to the alignment. After it has been adjusted, the angle of the cutter plate 18 remains fixed while the workpiece W is cut. In FIGS. 11A and 11B the cutter plate 18′ is shown ghosted in its initial position where it is extends exactly along the y-axis direction. The cutter plate 18 shown in FIGS. 11A and 11B is suitable for cutting a (r×4) array of images or designs.

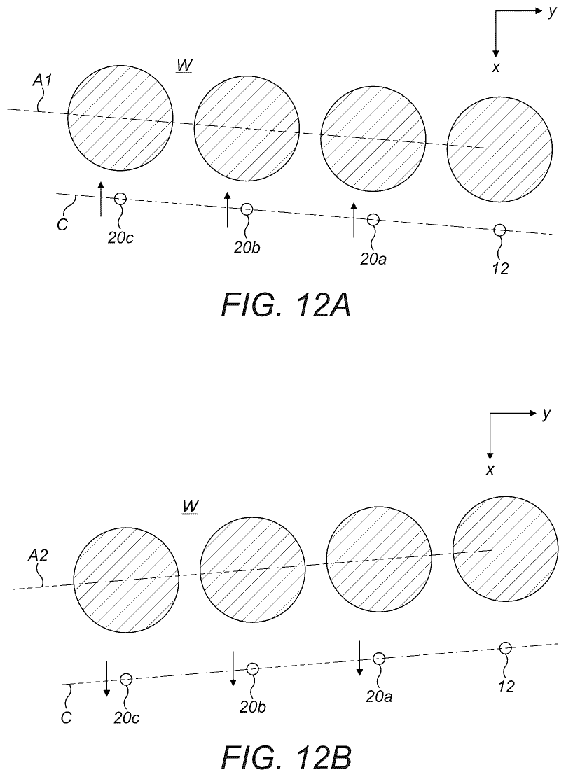

FIGS. 12A and 12B show how the angle of the cutter axis C can be adjusted to match the alignment A1, A2 of the rows of printed images or designs on the workpiece W. This alignment can be carried out without the need for a cutter plate 18. The secondary knives or blades 20a, 20b and 20c are mounted on the digital flatbed cutter so that they are movable in tandem with the primary knife or blade 12. In addition, each secondary knife or blade 20a, 20b and 20c can be moved along the x-axis direction by a suitable actuator (not shown). Each secondary knife or blade 20a, 20b and 20c may be moved the required distance along the x-axis direction—as indicated by the arrows-until the cutter axis C is parallel to the alignment A1, A2 of the rows of printed images or designs. (Suitable actuators (not shown) may also be used to adjust the spacing of the knives or blades along the cutter axis C. This may provide additional flexibility for spacing the knives or blades as compared with using a cutter plate.) In this example, the printed images or designs are not exactly aligned along the y-axis direction because of how the workpiece W is positioned on the flatbed 2. The misalignment is detected (e.g., using optical recognition of printed registration marks on the workpiece W) and the actuators are controlled to move the secondary knives or blades 20a, 20b and 20c an appropriate distance along the x-axis direction so that the angle of the cutter axis C matches the alignment A1, A2 of the printed images or designs. After it has been adjusted, the angle of the cutter axis C remains fixed while the workpiece W is cut. In other words, the secondary knives or blades 20a, 20b and 20c remain fixed in position relative to each other and the primary knife or blade 12 during the parallel cutting process. The primary and secondary knives or blades 12 and 20a, 20b and 20c shown in FIGS. 12A and 12B are suitable for cutting a (r×4) array of images or designs.

1. A digital flatbed cutter comprising:
a flatbed on which a printed workpiece can be positioned;
a head unit that is movable laterally along an x-axis direction and along a perpendicular y-axis direction in a parallel plane above the flatbed;
a primary cutter head mounted to the head unit and including a primary cutter assembly with a primary knife or blade for cutting the workpiece, the primary cutter assembly being movable along a z-axis direction that is normal to the plane and perpendicular to the x- and y-axes; and
at least one secondary knife or blade movable in tandem with the primary knife or blade for cutting the workpiece in parallel with the primary knife or blade;
wherein the primary knife or blade and the at least one secondary knife or blade are aligned and spaced apart along a cutter axis; and
wherein the angle of the cutter axis relative to the y-axis is adjustable.

2. The digital flatbed cutter of claim 1, wherein the knives or blades are substantially evenly spaced apart along the cutter axis.

3. The digital flatbed cutter of claim 1, further comprising a cutter plate mounted to the primary cutter assembly, the cutter plate comprising the at least one secondary knife or blade.

4. The digital flatbed cutter of claim 3, wherein the cutter plate extends substantially along the y-axis direction.

5. The digital flatbed cutter of claim 3, wherein the cutter plate is pivotally mounted to the primary cutter assembly.

6. The digital flatbed cutter of claim 3, wherein the cutter plate is removably mounted to the primary cutter assembly.

7. The digital flatbed cutter of claim 3, wherein the cutter plate includes at least one mounting means, each mounting means being configured to mount a respective secondary or blade.

8. The digital flatbed cutter of claim 3, wherein each secondary knife or blade is removably mounted to the cutter plate.

9. The digital flatbed cutter of claim 3, wherein the at least one secondary knife or blade is integrally formed with the cutter plate.

10. The digital flatbed cutter of claim 3, further comprising a plurality of different cutter plates, and wherein the primary cutter assembly further comprises a plate mount configured for removably mounting a selected one of the plurality of cutter plates.

11. The digital flatbed cutter of claim 3, wherein a first end of the cutter plate is removably mounted to the primary cutter assembly, wherein the digital flatbed cutter further comprises a secondary cutter head including a secondary cutter assembly being movable in tandem with the primary cutter assembly, and wherein a second end of the cutter plate is removably mounted to the secondary cutter assembly.

12. The digital flatbed cutter of claim 11, further comprising a support rail that extends over the flatbed, wherein the head unit is configured to be movable along the support rail in the y-axis direction.

13. The digital flatbed cutter of claim 12, wherein the secondary cutter head is configured to be movable along the support rail in the y-axis direction in tandem with the head unit and the primary cutter head.

14. A method of using a digital flatbed cutter comprising:
a flatbed;
a head unit that is movable laterally along an x-axis direction and along a perpendicular y-axis direction in a parallel plane above the flatbed;
a primary cutter head mounted to the head unit and including a primary cutter assembly with a primary knife or blade for cutting the workpiece, the primary cutter assembly being movable along a z-axis direction that is normal to the plane and perpendicular to the x- and y-axes; and
at least one secondary knife or blade movable in tandem with the primary knife or blade, wherein the primary knife or blade and the at least one secondary knife or blade are aligned and spaced apart along a cutter axis;
the method comprising:
positioning a workpiece on the flatbed; and
cutting the workpiece with each secondary knife or blade cutting the workpiece in parallel with the primary knife or blade.

15. The method of claim 14, further comprising adjusting the angle of the cutter axis relative to the y-axis before cutting the workpiece, and wherein the angle of the cutter axis is adjusted based on the orientation of the workpiece on the flatbed.

16. The method according to claim 14, further comprising pivotally mounting a cutter plate to the primary cutter assembly, the cutter plate comprising the at least one secondary knife or blade, and adjusting the angle of the cutter plate relative to the primary cutter assembly before cutting the workpiece.

17. A digital flatbed cutter comprising:
a flatbed on which a printed workpiece can be positioned;
a head unit that is movable laterally along an x-axis direction and along a perpendicular y-axis direction in a parallel plane above the flatbed;
a primary cutter head mounted to the head unit and including a primary cutter assembly with a primary knife or blade for cutting the workpiece, the primary cutter assembly being movable along a z-axis direction that is normal to the plane and perpendicular to the x- and y-axes; and
a cutter plate removably mounted to the primary cutter assembly, the cutter plate comprising at least one secondary knife or blade for cutting the workpiece in parallel with the primary knife or blade.

18. A method of using a digital flatbed cutter comprising:
a flatbed;
a head unit that is movable laterally along an x-axis direction and along a perpendicular y-axis direction in a parallel plane above the flatbed; and
a primary cutter head mounted to the head unit and including a primary cutter assembly with a primary knife or blade for cutting the workpiece, the primary cutter assembly being movable along a z-axis direction that is normal to the plane and perpendicular to the x- and y-axes;
the method comprising:
removably mounting a cutter plate to the primary cutter assembly, the cutter plate comprising at least one secondary knife or blade for cutting the workpiece in parallel with the primary knife or blade;
positioning a workpiece on the flatbed; and
cutting the workpiece with each secondary knife or blade cutting the workpiece in parallel with the primary knife or blade.

19. The method of claim 18, wherein the cutter plate is selected from a plurality of different cutter plates.

20. The method of claim 18, further comprising adjusting the angle of the cutter plate relative to the primary cutter assembly before cutting the workpiece.
